(19) United States
(12) Patent Application Publication
(10) Pub. No.: US 2010/0186824 A1
(43) Pub. Date: Jul. 29, 2010

(54) Gas-to-Liquid Plant Using Parallel Units

(76) Inventors: Michael Joseph Bowe, (US); Clive Derek Lee-Tuffnell, (US); Iain Kenneth Baxter, (US); Christopher Hopper, (US)

Correspondence Address: MCDERMOTT WILL & EMERY LLP, 600 13TH STREET, N.W., WASHINGTON, DC, 20005-3096, US

(21) Appl. No.: 12/718,633

(22) Filed: Mar. 5, 2010

Related U.S. Application Data
(63) Continuation of application No. PCT/GB2008/050887, filed on Oct. 1, 2008.

(30) Foreign Application Priority Data
Oct. 2, 2007 (GB) 0719163.8
Oct. 2, 2007 (GB) 0719167.9
Aug. 8, 2008 (GB) 0814532.8

(51) Int. Cl. F17D 3/00; B01J 7/00

(52) U.S. Cl. 137/2; 422/188

(57) ABSTRACT

A plant is provided for processing natural gas. The plant comprises two or more modules connected in parallel. The plant is configured to convert the associated gas into a material with a higher density. In addition, a method of processing gas associated with one or more oil wells. The method comprises the steps of: providing a modular plant comprising two or more modules in parallel wherein at least one of the modules is a robust module and at least one of the modules is an economical module; turning down one or more of the modules when productivity drops; switching off one or more of the modules at least when productivity drops beyond the turndown limit. The natural gas is treated in a Fischer-Tropsch unit.

### CROSS-REFERENCE TO RELATED APPLICATION

This application is a continuation of PCT Application No. PCT/GB2008/050887, filed Oct. 1, 2008 and claiming priority to GB Application No. 0719167.9 filed Oct. 2, 2007, GB Application No. 0719163.8 filed Oct. 2, 2007, and GB Application No. 0814532.8 filed Aug. 8, 2008, the disclosures of which are incorporated herein by reference in their entirety.

The invention encompasses a solution for processing associated gas. From another aspect, the invention relates to a plant for producing synthetic crude oil “syncrude”. In particular, the invention encompasses the production of syncrude from associated gas, and methods to achieve the same. Moreover, the invention relates to plant for handling associated gas, more particularly to a modular GTL plant for converting associated or stranded gas to synthetic crude oil.

Associated gas is a natural gas which is found in association with crude oil, either dissolved in the oil or as a cap of free gas above the oil. Associated gas is a by-product of oil extraction and is mostly an unwanted by-product that needs to be disposed of in the absence of means to capture and transport it.

Associated gas disposal options can cost in excess of US$100m whilst providing no direct economic benefit. Consequently, much of the gas has traditionally been flared. However, with increasingly stringent environmental regulations, flaring is becoming more and more unacceptable from a political and environmental viewpoint. In particular, gas flaring contributes to emissions of carbon monoxide, nitrous oxides and methane and is a source of noise and unwanted heat and light, affecting nearby communities and surrounding flora and fauna. In any event, an exhaustible resource is simply being wasted and oil producers operate inefficiently by not being able to generate income from associated gas utilisation.

Independent studies have estimated that global associated gas reserves with no commercial value due to a lack of processing capability exceed 1,000 trillion cubic feet (tcf) and are associated with over 700 mmbbls of oil. In 2003, the World Bank reported that 4.5 tcf of gas was flared worldwide. This is equivalent to the annual consumption of France and Germany combined, or 25% of US gas consumption. Additionally, 12.5 tcf of gas was re-injected globally. It is estimated that 50% of this represented distressed re-injection; or gas that is re-injected because of a lack of a viable or economic alternative.

One option of dealing with associated gas is to re-inject the extracted gas back into the oil field. However, this requires purification of the gas and compression, which creates additional costs that increase as reservoir pressure drops in line with production. In addition, re-injected gas may actually impair oil production by adversely affecting its flow.

An alternative is to find ways to bring the associated gas to market. Technically, there are several options for gas utilisation: preparing it as fuel in various forms (dried pipeline gas, LPGs, LNG, or gas to wire—onsite electricity generation) or processing for petrochemical feedstock. Other options currently under development include Gas-to-Liquids (GIL) and Gas-to-Solids (GTS). GTL technology provides a wide range of end-products with advantages over conventional petroleum alternatives, such as clean diesel and jet fuel, middle distillates, lubricants, olefins and methanol. GTS is a relatively new technology that is being developed specifically for off-shore gas production, in which gas is converted to hydrates to allow easier transportation to markets where it is re-gasified at the receiving terminal.

However, the processing of associated gas still remains unprofitable and is dependent on a ready market either for the gas itself or for products derived from the gas. In particular, oil companies see the production of a broad fraction of light hydrocarbons, a basic ingredient in the petrochemical industry, as the most promising use of associated gas. Another drawback when considering a solution for associated gas is the prohibitive cost of delivering gas to consuming regions. Long-distance pipelines and LNG, though proving quite viable for some cases, have not yet become routine gas delivery methods. A pipeline or conversion to LNG also presupposes a certain quantity of associated gas from an oil field to make such delivery and processing economically viable. Hence venting or flaring is often the most cost-effective solution. Other considerations are the health and safety aspects that must be included into a plant when handling flammable gas, as well as equipment operations and maintenance if the gas is too sour (i.e. has a high content of H₂S) or has a high liquid content.

Thus, there is a clear, continuing need to turn what has become a liability and cost for oil companies into an asset which generates positive economic returns. One of the considerable problems with handling associated gas is variability in the production rate and so there is a need to be able to handle associated gas, no matter how small or large the quantity of associated gas, over the lifetime of an oil field.

Conventional Gas-to-Liquid (GTL) plant is typically designed for onshore application and to enable the economic exploitation of large capacity gas fields (25,000+ barrels per day). Such plant typically costs billions of dollars, requires large plot areas and has a considerable weight. Indeed, the bigger the plant, the better the economic output from the plant. These plants generally convert gas into refined products such as waxes and lubricants using fixed bed, or fluidized bed slurry type reactors. It will be appreciated that such plant is not amenable to offshore locations, not least because of its size and weight.

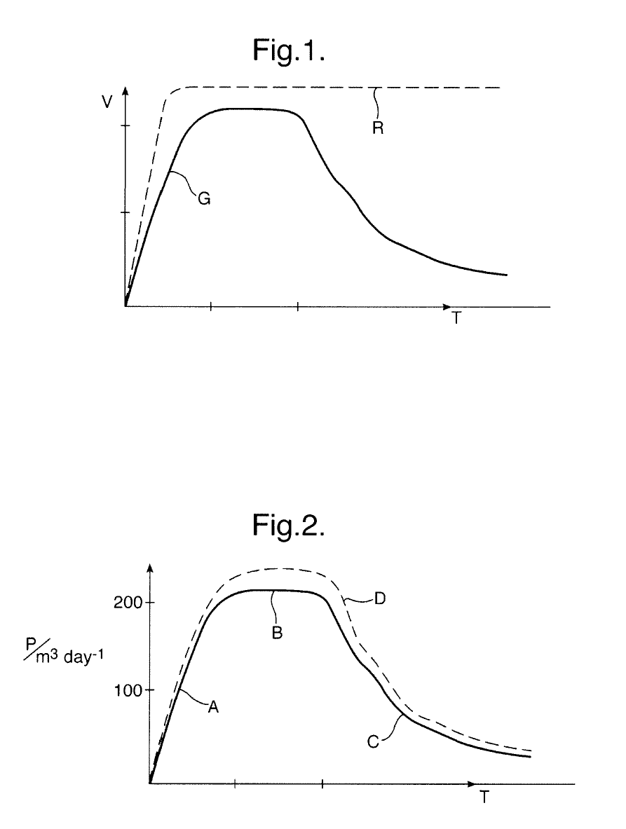

As the schematic graph showing variations of throughput or flow rate V with time T of FIG. 1 shows, the gas supply, R, required by a conventional GTL plant is more or less constant. In contrast, the gas productivity, G, i.e. the flow rate (measured in bbl/day or m³/day) of associated gas from an oil field varies over the operational life of an oil field, the life span of an oil field being typically in the range between three and twenty years. During an initial period, the productivity G increases to a maximum which plateaus for a period during which the productivity is substantially constant, after which the productivity gradually declines.

Over short-term periods, for example over a period of a few days or weeks, the productivity may fluctuate randomly, typically by about 10% of its mean value. Much shorter-term variations arise, for example if a well experiences an emergency shutdown. In this scenario, the flow from that well will drop to zero in a matter of minutes. Typically this might correspond to a reduction of 20% in the flow at an oil-producing facility with several wells. If the oil-producing facility is itself shut down in an emergency then the gas production will drop to zero over a matter of minutes or less.

While conventional refinery-scale GTL plant has the capacity to accommodate the daily fluctuations in productivity, such plant is designed for a full, long-term capacity and generally not to declining productivity from full capacity down to nearly zero. While large plant may be scaled down, there comes a point at which the plant is no longer economically viable. Looking at FIG. 1, it will be appreciated that, for handling associated gas, such conventional plant can only be effective for the early to mid part of the lifetime of an oil field. This then raises the question of whether it is economic to include a GTL facility into an oil-production plant.

To incorporate a GTL facility into an oil production plant, it is highly desirable for the GTL facility to be adaptable to accommodate variations in productivity of the oil field, particularly as productivity declines over the lifetime of a field. In order to adapt over time, a modular system is an ideal solution. Each module should be commercially sound when operated alone so that the GTL facility can be scaled to incorporate a number of modules at peak production, tailing off to a single module as the productivity of the site decreases.

GTL processes have been proposed that treat natural gas by a two stage process. In a first stage syngas is formed and in the second stage hydrocarbons are synthesised by Fischer-Tropsch synthesis. The syngas formation can occur by steam methane reforming (SMR) or by partial oxidation of the natural gas. Micro- and mini-channel technology has been developed for use in SMR and Fischer-Tropsch synthesis reactors, particularly with modularity in mind. However, there is a constant desire to improve technology, both scientifically and economically.

A new generation of syngas generating apparatus has been developed that relies on the use of Ion Transfer Membranes (ITMs) to bring about the production of syngas from natural gas. The ITMs are non-porous ceramic membranes that allow the simultaneous diffusion of oxygen ions and electrons.

A reactor for the conversion of natural gas to syngas using ITMs operates using two input streams, the first input stream being a combination of natural gas and steam and the second input stream being air. These streams are brought into contact with opposite surfaces of an ITM. On the surface on which the natural gas and steam combination is incident, the following reaction takes place:

CH₄+O²−→CO+2H₂+2e⁻

On the opposite surface of the ITM, oxygen from the air is ionised and the oxygen ions pass through the membrane.

½O₂+2e⁻→O²

The hydrogen and carbon monoxide may be used to generate syncrude via Fischer-Tropsch synthesis. The syncrude can then be mixed with oil with which the stranded gas was associated. As a result, no additional transportation costs are incurred as the syncrude is transported with the oil. However, a conventional plant for Fischer-Tropsch synthesis is on a very different scale from the compact plant that uses ITMs for syngas generation.

Thus, it is against this background that the present invention has been derived. In particular, consideration has been given to providing a complete economic solution to the associated gas problem and devising a GTL plant that is able to overcome the cost, size and inflexibility of conventional GTL plant. In particular, it has been appreciated that the associated gas market requires a scalable capacity, a flexible throughput and it must be suitable for offshore, as well as onshore, operation. Thus, in its broadest sense, the present invention encompasses an improved, modular, compact GTL plant.

The present invention provides a solution for associated gas. In particular, the invention resides in a plant for the extraction of oil and associated gas from an oil field, wherein the associated gas is converted from gas to synthetic crude oil (syncrude) and the syncrude is optionally co-mingled with extracted oil.

From another aspect, the present invention resides in a gas-to-liquid (GTL) plant for integration into an oil extraction plant, wherein the GTL plant converts gas to syncrude and the syncrude is optionally co-mingled with crude oil. The co-mingled crude and syncrude may then be stored and transported together for down-stream processing and refining.

In these aspects, the composition of the syncrude may be tailored by virtue of the modularity substantially to match the composition of the crude oil extracted from the oil field.

Furthermore, according to the present invention there is provided a GTL plant for processing associated gas, wherein the plant comprises at least one compact syngas reactor and at least one compact Fischer-Tropsch synthesis reactor.

In a further embodiment, two or more compact syngas reactors may be connected in parallel. In addition, or in an alternative embodiment two or more compact Fischer-Tropsch synthesis reactors may be connected in parallel. Each compact Fischer-Tropsch synthesis reactor may comprise a reactor block defining a multiplicity of channels for the Fischer-Tropsch synthesis reaction, each said channel containing a removable metal support carrying a catalytic active material. In a further embodiment, two Fischer-Tropsch reactors may be connected in series. Alternatively, or in addition, the GTL plant may comprise a first set of reactor modules comprising a plurality of equivalent compact Fischer-Tropsch synthesis reactors connected in parallel and a second set of reactor modules comprising a plurality of equivalent compact Fischer-Tropsch synthesis reactor modules connected in parallel, the second set being in series relationship to the first set.

In one example the or each syngas reactor comprises at least one ceramic membrane separating a channel carrying a gas stream comprising methane from a channel carrying a gas stream containing oxygen gas, and wherein the or each ceramic membrane allows diffusion of oxygen ions from the oxygen-containing gas stream into the methane-containing gas stream. Such a membrane may be referred to as an ion transport membrane (ITM). Each compact syngas reactor may comprise a pressure vessel enclosing the ceramic membranes. Each compact syngas reactor may also comprise a reforming catalyst.

Where the syngas reactor utilises a ceramic membrane through which oxygen ions can diffuse, the membrane separates a first gas flow containing oxygen from a second gas flow containing methane; preferably the second gas flow also contains steam. The reactions that occur in the second gas flow are analogous to those in a partial oxidation reactor if steam is not provided, or to those in an auto-thermal reforming reactor, if steam is provided. Catalysts may be provided on one or both sides of the ceramic membrane. Such a syngas reactor comprising a plurality of stacks of ceramic wafers is for example, described in U.S. Pat. No. 7,279,027, the details of which are incorporated herein by reference, where this is described as performing the partial oxidation reaction to obtain synthesis gas.

Ideally, the GTL plant will be integrated into, or close-coupled with, the oil extraction plant. By “oil extraction plant” is meant plant to extract, process and store crude oil from one or more oil wells. Thus, the GTL plant may fit anywhere within and into oil field processing and development plant. Advantageously, the oil extraction plant, or oil-producing facility, is in the vicinity of one or more oil wells to which oil flows from the wells, and at which the oil is given at least preliminary treatment prior to storage or transmission through a pipeline or other export facilities. For example, the plant or facility may be a fixed platform or a floating production, storage and offloading (FPSO) vessel. Typically such a facility would be connected to between one and twenty separate wells in a single field. The oil-producing facility might also refer to a smaller-scale facility, for example a well-test vessel.

It will be appreciated that by converting associated gas into a syncrude that essentially matches crude extracted from an oil field, specific export facilities for the gas are no longer required. In addition no specific storage of the products from the GIL process is needed, and no refining is needed. Indeed, it is envisaged that the co-mingled crude and syncrude are transported and refined together, using existing transport and plant networks. In this way, specialist plant for extracting storing and transporting particular fractions of syncrude are not required, and so the size, complexity and balance of the GTL plant may be significantly reduced which, in turn improves the economics.

In particular, if an investment has already been made into an oil field, plant, storage and transport networks will already be in use. The addition of a GTL plant in accordance with the present invention into the overall oil extraction plant, to handle associated gas, brings with it additional benefits. For example, any gas besides associated gas that is found at the oil field may also be extracted, thereby increasing the output and profit from the field. Expressed another way, the present invention has the potential to increase the economic output from an oil field. It may also, in some cases, extend the life of an oil field, not only because the quality or flow of the oil need not be jeopardised by re-injection, but because it provides the option of additional revenue from non-associated gas.

The GTL plant may be any compact GTL plant, provided it may be integrated, or close-coupled, with oil extraction plant. In particular, the GTL plant may comprise at least one steam/methane reforming (SMR) reactor and at least one reactor for carrying out Fischer-Tropsch (FT) synthesis. Fundamental differences between the GTL plant of the present invention and state-of the-art GTL plant are the size of the plant, and that the plant does not need to include means to convert the syncrude into refined products.

A typical (non-compact) GTL plant is the size and scale of an oil refinery, spanning many miles. While such plant is effective and economically viable for non-associated gas, and can be scaled down to a degree to handle large volumes of associated gas, there comes a point at which scale down becomes economically unviable. Thus, the use of typical GTL plant will be of limited value over the lifetime of an oil field where reserves, especially of associated gas, diminish. Such GTL plant can only be useful for part of the lifetime of the oil field and not the whole lifetime.

It will be appreciated that the plant of the present invention may be incorporated into an oil-producing facility that handles associated gas as well as oil. In such an embodiment, operation involves separating the gas from the oil, treating the gas for example by steam/methane reforming to produce synthesis gas using treatment plant close coupled to the oil/gas separator, and then subjecting the synthesis gas to Fischer-Tropsch synthesis to form longer chain hydrocarbons. The longer chain hydrocarbons may then be combined with the oil or may be refined into directly marketable products such as waxes, lubricant base oils, paraffin and naptha.

The overall result is to convert methane to hydrocarbons of higher molecular weight, which are usually liquid under ambient conditions. The two stages of the process, steam/methane reforming and Fischer-Tropsch synthesis, require different catalysts and therefore different catalytic reactors. The catalytic reactors enable heat to be transferred to or from the reacting gases, respectively, as the reactions are respectively endothermic and exothermic; the heat required for steam/methane reforming may be provided by combustion of methane.

The advantage of using compact or micro-reactors is that the capacity of plant using such reactors may easily be altered to accommodate variations in gas supply including, for example, changes in supply over the lifetime of an oil field, shutdown of a well over a time period of days and weeks and even transient fluctuations in supply over seconds, minutes or hours. Furthermore, the plant can be matched more easily to the gas profile as small-scale reactors provide a more flexible way of designing and building a plant. This is in contrast to typical GTL plant in which gas profile is usually matched to the plant because the plant design and requirements provide less flexibility.

The present invention also provides a process plant for handling associated gas, the plant comprising a separator to separate the gas from the oil, a gas treatment plant close coupled to the oil/gas separator for producing synthesis gas by steam/methane reforming and comprising a plurality of equivalent modular reforming reactors connected in parallel, the process plant further comprising a plurality of equivalent modular synthesis reactors connected in parallel for performing Fischer-Tropsch synthesis and so producing longer chain hydrocarbons. The plant may further comprise means to combine the longer chain hydrocarbons with the oil.

The ability to operate satisfactorily despite changes in the rate of production of associated gas is especially important when dealing with associated gas and where the gas is treated in a location close coupled to the oil/gas separator.

The present invention also encompasses a plant wherein one or more modules in the plant is exchanged for a substantially identical module in which the substantially identical module includes new or re-conditioned catalyst.

Preferably the reactors include removable catalyst in some or all of the reactor channels. The catalyst in these reactors has a finite life span and, because of the design of the reactors, may be removed and replaced, or simply reconditioned. In this way, the reactor and hence module may be re-used, either in its original plant, or used to replace a module in a plant at a different location.

The present invention also encompasses a module for use in the GTL plant of the invention, the module comprising at least one syngas reactor, which may be an SMR reactor. In one embodiment, the module further comprises at least one FT reactor. Catalyst in the reactor(s) may be new or may be reconditioned.

It will be appreciated that the invention may be practiced on-shore or off-shore. The present invention is of particular use to off-shore production, such as on an FPSO, where plant and storage space is at a premium and transport and handling at sea provide added obstacles. The use of compact mini-channel or micro-channel reactors enables the GTL plant to be located on the same FPSO as the oil extraction plant, thereby reducing the overall plant costs for an oil field.

The present invention is particularly suited to facilities where the gas to oil ratio is between about 35 and 350 m³/m³ (between about 200 and 2000 scf/bbl, where 1 bbl=1 barrel=42 US gallons, and 1 scf=1 cubic foot at STP), although it may be used in facilities where the ratio is somewhat lower, say as low as 15 m³/m³. This is in contrast to the non-associated gas GTL plants that typically produce from gas or condensate fields with a gas to oil ratio of greater than 5000 m³/m³. The term “gas to oil ratio” means the ratio of the volume of associated gas measured at STP to the volume of oil. For larger gas to oil ratios, it may be more cost-effective to treat the gas in another way, for example to produce liquefied natural gas. For significantly smaller gas to oil ratios there may be insufficient gas available for the process to be economic, and indeed the oil-producing facility may itself require some natural gas to power its own operation.

From one aspect, the present invention encompasses a GTL plant in which components of the plant are modular. Expressed in another way, the present invention resides in a GTL plant for processing associated gas, wherein the plant comprises one or more modular components.

In one embodiment, the plant comprises one or more modules, wherein each module comprises at least one syngas generating reactor and at least one Fischer-Tropsch (FT) reactor. In another embodiment, a module comprises one or more syngas generating reactors, or comprises one or more Fischer-Tropsch (FT) reactors. In yet another embodiment, a plant comprises a plurality of syngas generating reactor modules and a plurality of Fischer-Tropsch (FT) reactor modules. Each of the syngas generating reactors may be an SMR reactor.

In this way, a GIL plant may be constructed to reflect the gas profile. In particular, a GTL plant may be constructed to accommodate a declining gas profile. This is contrary to current GTL construction in which a GTL plant has a fixed productivity and a fixed feedrate. With the plant of the present invention, modules may be added or subtracted according to the amount of gas available, thereby allowing the productivity of the GTL plant as a whole to be tailored to the amount of gas available and the varying gas production levels over the life of a field. In this way, the productivity of the GTL plant can be maximised. That is to say, the number of reactor modules may be adjusted to match the associated gas production profile over time. In particular, as gas production declines, individual modules may be simply shut down or may be removed from the plant altogether. In particular, oil/gas field A may have a gas production capacity of X, while oil/gas field B may have a capacity of 2×. To increase capacity, rather than making reactors bigger and extending areas of pipework etc, capacity can be increased by simply adding modules to provide a GTL plant of a desired capacity. This is an important consideration when handling associated gas because the minimum level of gas that must be handled will be next to zero. The capacity of the GTL plant is selected so that when the plant is working at full capacity it can process 100% of the associated gas produced by the oil/gas field. Thus, the GTL plant must be able to cope, economically and technically, with variations in productivity between 10 to 100%. The modularity of the present invention allows this hurdle to be substantially overcome.

GTL plant can be turned down to a limited extent in order to deal with short term fluctuations in gas production. Different reactors can be turned down by different percentages depending on the catalysts used and the reactor geometry. The overall percentage turn down of a GTL plant is limited by the turn down of the least tolerant component which might be capable of a 50% turn down. Therefore the productivity range of a conventional plant is 50% to 100%.

In a modular plant, the maximum turn down that is achievable is where all but one of the modules have been switched off and the one remaining module has been turned down. For example, in a plant with five modules, each capable of being turned down to 50%, the productivity range is 10% to 100%.

In a modular plant, the overall turn down may be limited by the turn down capability of the reactors or by auxiliary components such as the compressors, pre-heaters and gas pre-treatment units including desulphurisation and mercury removal. The performance of these auxiliary components may be adversely affected by very low gas flow rates.

If a reduction in associated gas production is too severe to be dealt with by turning down the modules, but it likely to be sufficiently short lived that it is not convenient to shut down one or more of the modules, the associated gas feed can be at least partially replaced with methanol. This has the advantage that the reactors can be maintained at operating temperature so that they can be switched back to associated gas as soon as the production rate of the associated gas is sufficient.

Another issue to consider with handling associated gas, apart from fluctuations and changes in the amount of gas, is that the composition of the gas changes of the lifetime of an oil field. If the composition changes, in a plant where the gas is processed by pre-reforming to provide a standardised gas composition for introduction to the syngas generation reactors, the composition change will lead to a volume change. Hence a modular plant can be more easily tuned to cope with compositional changes compared to larger capacity plant.

The or each module may comprise one or more reactors arranged in series, in parallel or a combination thereof. Indeed, the or each module may comprise two or more reactors arranged in series, in parallel or a combination thereof. For example, an FT module may comprise a number of FT reactor blocks welded together. In another example, an FT module may comprise two sets of FT reactor blocks aligned in series. In this way, the syngas may be passed through one block of FT reactors, thereby providing partial conversion of the syngas to syncrude, before passing the remaining syngas through a second FT reactor block. The output from the first FT reactor may be treated, for example to separate the condensable liquids from the output, before the remaining syngas is passed through the second FT reactor block.

Preferably the synthesis gas production is carried out using a plurality of modular reactors operating in parallel. Similarly, it is preferable if the Fischer-Tropsch synthesis is carried out using a plurality of modular synthesis reactors operating in parallel.

In a preferred embodiment, it is envisaged that the reactors that make up the or each module are compact reactors or mini-channel reactors, such as those described in WO 01/51194 (Accentus pic) or WO 2006/79848 (CompactGTL plc) or micro-reactors, for example as described in U.S. Pat. No. 6,668,534 (Wang et al) or U.S. Pat. No. 6,616,909 (Tonkovich et al) the details of which are incorporated herein by reference. Such reactors are ideally designed for modularity because their size and weight allows sufficient flexibility. Indeed, such compact reactors are particularly suitable for offshore use, particularly since the Fischer-Tropsch reactors do not require the use of fluidised beds. A further benefit of the overall process is that it does not require the provision of a pure oxygen supply. Furthermore, such reactors allow the construction of economic plant as small as 200 barrels per day. The reactors are also known to have a small liquid inventory which is a significant consideration when designing offshore plant, and the reactors as modules can, because of their small size, easily be incorporated into a floating production, storage and offloading (FPSO) vessel or a production platform.

Another significant advantage of the present invention is that if a module develops a fault, or the catalyst degrades, the module may be removed and replaced without significantly affecting the output of the plant as a whole, or indeed requiring the plant to be shut down and replaced in totality. In another embodiment, the plant may include “spare” or back-up modules that provide additional capacity should productivity suddenly increase or a module fall out of action.

Ideally, the modules are equivalent and interchangeable. By this it is envisaged that a module is of a standardised size, can be removed by standard handling equipment and replaced by a similarly standard sized replacement module. Preferably the modules, whether for synthesis gas formation, for example by reforming, or for synthesis, are of such a size as to fit within the dimensions of an ISO container and are of weight no more than about 35 tonnes, preferably no more than 25 tonnes and more preferably no more than 15 tonnes. Consequently each module may be installed and replaced using lifting equipment that is conventionally available for use on oil platforms and on FPSO vessels.

If a larger number of smaller modules is deployed to process the associated gas emanating from an oil well or a group of oil wells, then there will be an increased requirement for manifolds and valves to connect and control the flow of associated gas to and product from each of the modules that make up the plant. Therefore, although it is preferable to reduce the weight of the module sufficiently to allow standard handling equipment for lifting ISO containers to be used to deploy the modules, the weights given above are examples of the weight limits of these pieces of equipment and should not be construed as a desire to reduce the weight of a module beyond the limit imposed by the handling equipment.

In a particularly preferred embodiment, the plant allows gas treatment, synthesis gas formation and synthesis, including Fischer-Tropsch synthesis, to be carried out on a scale optimised preferably for producing no more than about 800 m³/day (5000 bbl/day) or no more than 950 m³/day (6000 bbl/day) of longer chain hydrocarbons, for example C5+. This corresponds to the treatment of no more than about 2.0×10⁶ m³/day (70 Mscf/day) or 2.5×10⁶ m³/day (85 Mscf/day) of gas (although the corresponding quantity of gas will depend on the degree of integration between the process plant including gas treatment, reforming and synthesis plant and other operations of the oil-producing facility). Such a plant can fit on an oil well platform or on a FPSO vessel.

From another aspect, the present invention provides a method for operating an oil-producing facility that produces associated gas along with oil, wherein the method involves the steps of separating the gas from the oil, treating the gas by steam/methane reforming to produce synthesis gas using treatment plant close-coupled to the oil/gas separator, subjecting the synthesis gas to Fischer-Tropsch synthesis to form longer chain hydrocarbons, and combining the longer chain hydrocarbons with the oil.

The steam/methane reforming may be carried out using at least one catalytic reactor and the Fischer-Tropsch synthesis may be carried out using at least one catalytic reactor. The reactors may contain respective catalysts.

As described above in relation to FIG. 1, there are a number of reasons why the production rate may vary. Some of these variations are long-term variations over months or years, while others are short-term variations over hours or minutes or less. The short-term variations are typically in the range of +/−20% relative to the mean gas flow rate. Typically once every year the plant and the entire oil-producing facility will be shut down for servicing. The plant is preferably capable of accommodating any such changes and fluctuations.

From a yet further aspect, the present invention resides in a method for re-using reactor modules, the method comprising removing a module from plant of the invention, transporting the module to a site away from the plant and reconditioning or replacing catalyst present in the or each reactor within the module. If the module is removed because the capacity provided by the module is no longer required, the module may be refurbished and re-used in a plant at a different location.

The present invention also encompasses a method, wherein the synthesis gas production is carried out using an ITM-containing reactor and the Fischer-Tropsch synthesis is carried out using a catalytic reactor, at least the Fischer-Tropsch synthesis reactor containing a catalyst, and wherein the method involves removal and replacement of a synthesis reactor and optionally a syngas reactor when the catalyst is to be replaced.

Over the course of time, a reactor may require replacement and/or refurbishment for a range of different reasons, some of which have a more serious effect on the performance of the reactor than others. The phrase “reactor requires replacement” should not be taken as meaning that the reactor has necessarily ceased to function. In particular the replacement of a reactor may be scheduled in advance. For example, each reactor may be scheduled for replacement after operation for four or five years, whether or not its performance has deteriorated at that time. In this case, the reactor would be said to require replacement. A module may be removed from plant, transported to a site away from the plant and reconditioned. When the module is removed, it may be replaced with a substantially identical module if the plant productivity is to be maintained. If the module is removed because the capacity provided by the module is no longer required, the module may be refurbished and re-used in a plant at a different location.

Refurbishment may, for example, involve replacing catalyst, removing a blockage, or removing a foreign body broken off from upstream within the process plant. Catalyst replacement may form part of the refurbishment whether or not the catalyst is spent.

If the level of productivity is to be maintained, the replacement reactor enables the process to continue operating in an unchanged fashion. Furthermore, if there are a plurality of equivalent reactors in parallel only one of which is removed at a time, the removal of such a reactor does not require the entire process to be stopped. The refurbishment facility may be remote from the plant or oil-producing facility. Consequently, there is no requirement for the GTL plant or oil-producing facility to have any catalyst-handling equipment.

The present invention also provides such a method, wherein the steam/methane reforming is carried out using a catalytic reactor, and the Fischer-Tropsch synthesis is carried out using a catalytic reactor, the reactors containing respective catalysts, and wherein the method involves removal and replacement of a reforming reactor or of a synthesis reactor when the respective catalyst is to be replaced.

Furthermore, according to the present invention there is provided a process for use at an oil-producing facility that produces associated gas along with oil, wherein the process involves the steps of separating the gas from the oil, treating the gas by steam/methane reforming to produce synthesis gas using treatment plant close coupled to the oil/gas separator, and then subjecting the synthesis gas to Fischer-Tropsch synthesis to form longer chain hydrocarbons, and then combining the longer chain hydrocarbons with the oil, wherein the steam/methane reforming is carried out using a plurality of equivalent modular catalytic reforming reactors connected to each other, and the Fischer-Tropsch synthesis is carried out using a plurality of equivalent modular catalytic synthesis reactors connected to each other, the reactors containing respective catalysts, and wherein the method involves removal and replacement of a reforming reactor or of a synthesis reactor when a reactor requires replacement.

The oil-producing facility may comprise a floating production, storage and offloading vessel on which the process is performed. The number of reactors in parallel, both for reforming and for Fischer-Tropsch synthesis may be at least three. The process may further comprise removing and replacing a reforming reactor or a synthesis reactor when the respective catalyst is to be replaced. Additionally, the process may further comprise taking the removed reactor to a remote treatment facility for refurbishment.

Furthermore, according to the present invention there is provided a process for use at an oil-producing facility that produces associated gas along with oil. The process involves the steps of separating the gas from the oil, treating the gas to produce synthesis gas using treatment plant close-coupled to the oil/gas separator, subjecting the synthesis gas to Fischer-Tropsch synthesis to form longer chain hydrocarbons, and then combining the longer chain hydrocarbons with the oil. The synthesis gas production is carried out using a plurality of equivalent modular syngas reactors connected to each other. Each syngas reactor comprises a multiplicity of ceramic membranes separating a channel carrying a gas stream comprising methane from a channel carrying a gas stream comprising oxygen, each ceramic membrane allowing diffusion of oxygen ions therethrough. The Fischer-Tropsch synthesis is carried out using a plurality of equivalent modular catalytic synthesis reactors connected to each other, the reactors containing respective catalysts. The method further involves removal and replacement of a syngas reactor or of a synthesis reactor when a reactor requires replacement and/or refurbishment.

The associated gas will typically require additional conditioning treatment before the steam/methane reforming treatment, for example to remove any traces of mercury, chloride and sulphur and, if the associated gas contains C2+ hydrocarbons, it is preferably subjected to pre-reforming to convert these C2+ hydrocarbons to methane.

It is advantageous if the process recycles water produced by the Fischer-Tropsch synthesis to provide steam for reforming as this minimises the net water consumption of the process. In any event, the Fischer-Tropsch synthesis process produces a similar volume of water to that of the longer chain hydrocarbons and this produced water would otherwise have to be disposed of as waste.

Another by-product of the GTL process may be hydrogen, as the steam/methane reforming reaction produces an excess of hydrogen over that required for the Fischer-Tropsch synthesis reaction. This hydrogen gas may be separated from other gases after synthesis gas production and/or after Fischer-Tropsch synthesis and may be used as a source of energy either for combustion (for heat) or to provide a fuel for generating mechanical power or electricity, for example to provide the power to operate the GTL process. The synthesis gas production requires heat which is advantageously provided by combustion of methane or natural gas, preferably using catalytic combustion, although some hydrogen may also be used for this purpose.

Preferably the synthesis gas production, in particular by the steam/methane reforming treatment is carried out at a pressure between 1 and 15 bar (absolute). The Fischer-Tropsch synthesis is preferably carried out at above 18 bar. The pressure at which the synthesis gas production is carried out determines the minimum number of compressor stages required, because each compressor stage in practice raises the pressure by a factor of about two.

Ideally the synthesis gas production is carried out at a pressure that minimises the number of compressor stages, as compressors are costly pieces of equipment. Preferably the synthesis gas production is carried out at between 2 and 6 bar, so the number of compressor stages is between two and four. However, it may be possible to operate a syngas reactor utilising ITM technology at a pressure above 15 bar that is similar to the pressure required for Fischer Tropsch synthesis. As a result, the number of compressor stages required between an ITM syngas reactor and an FT reactor may be reduced in comparison with that required between a typical Steam Methane Reforming reactor and an FT reactor in known compact systems, and the use of ITM technology may even obviate the need for a compressor between the syngas generator and the FT reactor.

Where synthesis gas is produced by steam methane reforming, the reforming reactors contain channels for the reforming reaction adjacent to channels for supplying heat, while the heat-supplying channels preferably incorporate a catalyst so that the heat is produced by catalytic combustion. Preferably the maximum temperature in the heat-supplying channels of the reforming reactors does not exceed 815° C., more preferably not exceeding 800° C. The maximum temperature within the reforming channels therefore preferably does not exceed 800° C. and more preferably does not exceed 780° C. This operating temperature is sufficiently low that compliance with construction codes can be readily ensured, especially for brazed structures.

Between the synthesis gas production and the Fischer-Tropsch synthesis, the synthesis gas is subjected to compression, preferably in two or three successive compression stages, with cooling and removal of condensed water vapour between successive compression stages. The Fischer-Tropsch synthesis is preferably carried out at a pressure of between 18 and 28 bar(a), more preferably at between 24 and 27 bar(a), most preferably about 26 bar(a). The synthesis gas may also be treated, before the Fischer-Tropsch synthesis stage, to remove some of the excess hydrogen, for example using a hydrogen-permeable membrane, so that the hydrogen to CO ratio in the synthesis gas fed to the Fischer-Tropsch synthesis is the range 2.05 and 2.50, preferably between 2.1 and 2.4.

The Fischer-Tropsch synthesis may be performed in a plurality of successive stages, the gases being treated to condense and remove water and longer chain hydrocarbons between one stage and the next. In this case, each stage would desirably use a plurality of modular synthesis reactors operating in parallel.

In summary, the invention effectively increases the quantity of crude oil provided by a well, on a continuous basis, by adding the longer chain hydrocarbons to the crude oil. For example, the quantity of oil may be increased by typically between about 5 and 20%. This can also increase the economic life of the oil well. It also significantly reduces the quantity of gaseous hydrocarbons that are flared at the production site, which has environmental benefits and may permit development of an oil well that would otherwise be unacceptable. Since the longer chain hydrocarbons are merely combined with the oil, no additional storage or transport equipment is required and there is no need to find a separate market for the longer chain hydrocarbons.

Furthermore, according to the present invention there is provided plant for processing natural gas comprising two or more modules connected in parallel; wherein the plant is configured to convert the associated gas into a material with a higher density.

In this context the “material” could be a solid, a liquid or a gas. There are a number of different ways in which the density of natural gas can be increased. The gas can be subjected to a physical process such as cooling or compression to create liquefied natural gas (LNG) or compressed natural gas (CNG). Alternatively, the density can be increased by a chemical process involving treating the natural gas using one or more catalytic reactions to produce a product that is liquid in ambient conditions. In this context “ambient conditions” means atmospheric pressure and temperatures in the range of 5° C. to 30° C. One example of a chemical process by which the density of the gas can be increased is a Gas to Liquid (GTL) process, in particular a process of converting the methane in natural gas to hydrocarbons of higher molecular weight, typically C5+. Other chemical processes that can increase the density would convert the gas to urea, to olefins, to methanol or to dimethyl ether.

Moreover, an advantage of the current invention is that at least one of the modules may be a robust module. Robust modules are modules that are more tolerant of transient changes in process conditions, for example changes in the temperature and/or pressure that may be associated with changes in load and throughput that occur during the start-up or shut-down of one or more of the reactors in a module. Transient changes in the process conditions may also occur as a result of a change in gas specification. Furthermore, changes in the required product to be output from the Fischer-Tropsch modules may result in changes in the process conditions. Robust modules may be more expensive to buy and/or to run than modules that are not robust. For this reason, in the context of this specification, modules that are not classified as “robust” are referred to as “economical”.

Each module may comprise two or more reactors connected in series or in parallel or a combination thereof. A reactor comprises one or more reaction blocks connected by one or more headers. There is a manufacturing limit on the size of a reaction block. A reactor may be made up from one or more reaction blocks. Where a reactor includes more than one reaction block, the blocks may be fixed together to form a single large reactor with a single common header. Alternatively, a number of reaction blocks may communicate through a collection of smaller headers. However, this collection of reaction blocks can still be referred to as a reactor.

The provision of two or more reactors in series allows two-stage reactions to be carried out within a single module. The reaction blocks providing these two stages may form two distinct reactors or the blocks for the two stages may be interspersed, for example arranged alternately. It may be preferable for the second stage reactor to be differently configured from the first stage reactor, for example the first stage reactor may be more robust than the second stage reactor. The provision of two or more reactors in parallel within one module increases the capacity of the module as a whole beyond what could be achieved by a single such reactor.

Two or more of the modules may be syngas generating modules that contain one or more syngas generating reactors and two or more of the modules may be Fischer-Tropsch modules that contain Fischer-Tropsch reactors.

All of the syngas generating modules may be arranged in parallel; and all of the Fischer-Tropsch modules may be arranged in parallel. By arranging modules containing reactors for performing the same reaction in parallel with one another, one module can be removed without interrupting the activity of the remaining modules.

There may be at least five syngas generating modules arranged in parallel; and there may be at least five Fischer-Tropsch modules arranged in parallel.

The outputs of a plurality of the syngas generating modules may be connected to a common output manifold. The provision of a manifold to pool the outputs from a plurality of the syngas generating modules allows any differences in the outputs of those modules to be smoothed out. It also allows for the situation wherein the number of syngas generating modules is not the same as the number of Fischer-Tropsch modules.

The syngas generating modules may be configured to generate syngas using steam methane reforming. If the percentage of the associated gas that is CO₂ is high then other reforming processes may occur simultaneously with steam methane reforming. For example, dry reforming and partial oxidation may occur.

The syngas generating modules may be configured to generate syngas using Ion Transfer Membranes.

The syngas generating module(s) may further comprise means for raising steam using the thermal energy output from the syngas generation.

The syngas generating module(s) may further comprise a recuperator connected to a combustion gas outlet. The recuperator is configured to extract the heat from the exhaust from the combustion channels.

The syngas generating module(s) may further comprise at least one pre-heater and/or at least one pre-reformer.

Each Fischer-Tropsch module may comprise: at least two Fischer-Tropsch reactors connected in series and means for connecting the output of the first Fischer-Tropsch reactor to preheaters and phase separators external to the module. By providing ducting or similar means by which to feed the output from the first Fischer-Tropsch reactor to phase separators and preheaters that are external to the module, these auxiliary components can be common to more than one module and, in addition, they do not have to be housed within the module. As the phase separators and preheaters are not likely to have the same life time as the reactors, it may be advantageous to have them external to the module so that the module can be removed and replaced at different times from the replacement of the phase separators and preheaters.

The Fischer-Tropsch module(s) may further comprise at least one preheater and at least one phase separator.

The number of modules may be selected so that the plant is sized to process 100% of the associated gas produced by the oil well(s). Indeed, there may be provided at least one module that is redundant under normal operating conditions. If a redundant module is retained it provides additional capacity at a time of increased gas flow rate. However, because the module is not switched on, any catalyst is not being degraded through use and, in addition, the plant as a whole can be turned down further than would be possible if the redundant module were to be retained switched on as an active part of the plant.

Furthermore, according to the present invention there is provided apparatus for processing natural gas, the apparatus comprising: a production conduit for communication with an oil well in order to extract oil and associated gas; and a process unit configured to support means for storing the oil extracted and also a plant as described above. The production conduit may be attached to a subsea or other land based oil well. The process unit may be on a fixed or floating platform. If the oil well is a subsea oil well, there may also be provided a system configured to anchor the process unit to the sea bed. However, the process unit may be dynamically positioned and therefore there may be no need to anchor it. The process unit may be an FPSO.

The apparatus may further comprise means for separating the oil from the associated gas. The separation of the oil from the gas may occur at the well or on the process unit.

Moreover, in accordance with the present invention there is provided a method of processing gas associated with one or more oil wells, the method comprising the steps of providing a modular plant comprising two or more modules in parallel wherein at least one of the modules is a robust module and at least one of the modules is an economical module; turning down one or more of the modules when productivity drops; switching off one or more of the modules at least when productivity drops beyond the turndown limit.

The switching off of one or more modules when the productivity drops to less than the turndown limit enables the remaining modules to continue to operate within acceptable turndown limits despite the overall productivity of the oil well having dropped to a level of productivity that is so low that a single non-modular plant would not be able to cope. For a plant comprising n syngas generating modules, the switching off of one module may occur when the flow rate of the associated gas falls to below 100(n−1)/n % of full capacity. The turndown limit of each module may be in the region of 50% to 60% and therefore for a plant where n>2, it will be practical to close down a module before the plant as a whole reaches its turndown limit.

If the drop in productivity is merely a fluctuation that is expected to have a short duration, the module that is switched off when the flow of associated gas drops below the threshold at which turndown becomes impractical may be a robust module. A robust module is the first to be switched off in this circumstance because the robust modules can tolerate more rapid temperature changes and therefore the robust module can be brought back online more quickly when the gas flow rate increases again. If the plant is a GTL plant the robust modules may have a higher thermal inertia than the economical modules. If the fluctuation is very short lived then the robust module may still be close to operating temperature and it can therefore be brought online very quickly. In comparison an economical module would have cooled down more and would be more sensitive to the temperature being increased back to production temperatures.

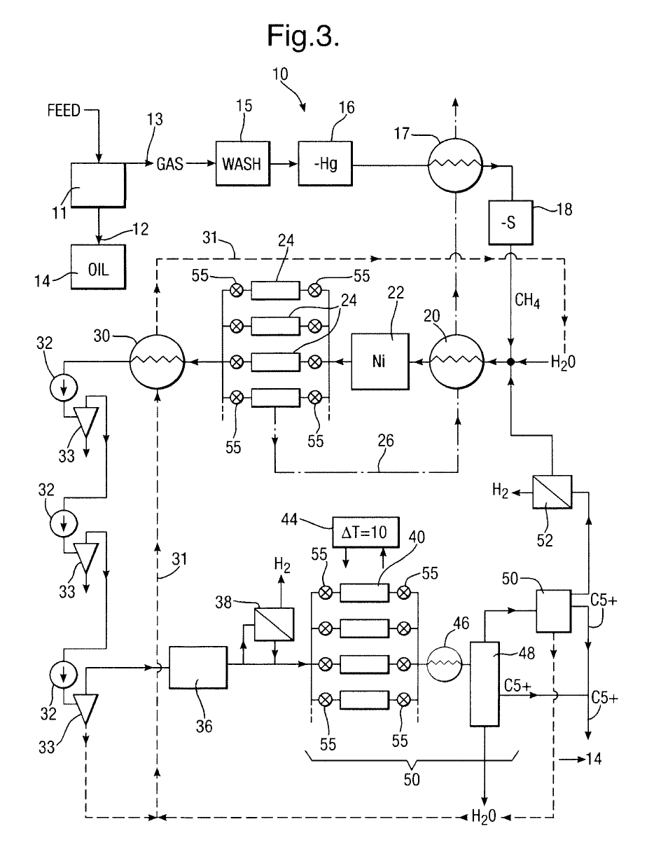

The method may further comprise the step of turning off one module when the flow of associated gas falls to below a predetermined threshold for in excess of a predetermined time period. For example, in a system having five modules, if the flow of associated gas falls to below 80% for more than six months this may be indicative of a long term decline in the productivity of the well, as shown in zone C of FIG. 2. In this case, one of the modules can be switched off and may be removed. This helps the remaining modules to deal with deeper dips in associated gas flow through turn-down alone. Continuing with the above example, the remaining four modules will be able to cope with fluctuations in associated gas flow down as low as 40% of initial productivity (80% of 50%) and therefore the reliance on the robust module(s) will be reduced. The switching off and removal of a module also increases the overall utilisation of the modules as the module that has been switched off can be removed and redeployed into a plant at a different oil well.

The module that is switched off in this case may be an economical module. In order for the plant to retain maximum flexibility to deal with fluctuations in gas flow it is important that at least one robust module should remain within the plant. Therefore, the first module to be switched off should be an economical module. This module may then be removed from the plant for refurbishment or servicing or for redeployment elsewhere.

The modular plant may be configured to convert associated gas to liquid hydrocarbons, wherein the liquid hydrocarbons are combined with the oil from the oil well(s). The combination of the synthetic crude oil or liquid hydrocarbons with the crude oil from the well completes the solution to the associated gas problem because no additional transport infrastructure is required over and above that which is provided to deal with the oil itself.

The modular plant may be configured to carry out the following steps: separating the associated gas from the oil; treating the gas in a first catalytic reactor to produce syngas; and treating the syngas by Fischer-Tropsch synthesis to form longer chain hydrocarbons that are liquid under ambient conditions.

Furthermore, the plant may be configured to provide at least the economical syngas generating modules with methanol as combustion fuel during a short term reduction in productivity. If the flow of associated gas drops to a very low level over a very short time period, for example, as a result of an interruption to activity at the oil well, the flow of associated gas may suddenly drop to almost zero. In these circumstances, it may be appropriate to turn off all of the modules and to provide the economical modules with methanol as a fuel in order to maintain the syngas reactors at operating temperature ready to process the associated gas when it comes back on line. Depending on the availability of methanol and the duration of the outage, it may be appropriate to provide the robust modules with methanol as fuel as well as the economical modules, or instead to allow the robust modules to cool down naturally towards ambient conditions.

In addition, or in place of the use of methanol or other liquid fuel, hot exhaust gases from processes elsewhere within the plant may be used in order to keep the module at operating temperature. In particular, an exhaust from a diesel combustion process may be used. Furthermore, electrical heating may be provided within the modules and this may be used either in addition or in place of the alternative gas supplies outlined above.

Furthermore, according to the present invention there is provided control system for operating a plant as described above in accordance with the method as described above. The control system allows the fully flexibility of the plant to be exploited.

The control system may further comprise means for monitoring the composition of the synthetic crude oil exiting the Fischer-Tropsch reactors and means for modifying the conditions within the Fischer-Tropsch reactors in order to match or complement the composition of the output to the composition of the oil from the well(s). The temperature and syngas composition within the Fischer-Tropsch reactors have a considerable impact on the proportion of different liquid hydrocarbons that are produced by the reactors. Therefore by altering the temperature in the Fischer-Tropsch reactors the composition of the resultant synthetic crude oil can be modified to match the composition of the crude oil output from the well. In some circumstances, it may be preferable to select the composition of the synthetic crude so that it complements, rather than matches the composition of the crude oil from the well.

The term “oil-producing facility” refers to a facility in the vicinity of one or more oil wells to which oil flows from the wells, and at which the oil is given at least preliminary treatment prior to storage or transmission through a pipeline. For example, it may refer to a fixed platform or to a floating production, storage and offloading (FPSO) vessel. Typically such a facility would be connected to between one and twenty separate wells in a single field. It might also refer to a smaller-scale facility, for example a well test vessel.

The terms “integrated” and “close-coupled” mean that the GTL plant takes gas after it has been separated from the oil, without requiring significant chemical processing. Thus, the GTL plant of the present invention may accept both treated and untreated gas.

The term “equivalent” means that the reactors are designed to have substantially the same performance and have compatible connections to flow ducts (for the reactants or for coolant), so that one reactor can readily be installed in place of another. Once installed, the equivalent reactor will have substantially the same throughput and chemical performance as the replaced reactor. It will be appreciated that in practice such reactors may differ in their chemical performance, for example due to ageing of the catalyst. The modular reactors are not necessarily identical in shape and size, although that would be preferable, as manufacturing identical reactors is usually more economical.

The term “compact” when used in the context of the present invention includes a reactor that provides a large surface area for catalyst and for heat exchange within a small volume. In particular, a compact reactor is sized and configured for use at an oil-producing facility. To be usable at an oil-producing facility the reactor is sized to fit on a fixed off-shore oil platform or an FPSO vessel. To facilitate the installation, maintenance and removal of such a reactor, the module is ideally sized so that it can be handled by conventional cargo handling equipment. For example, a compact reactor should be sized to fit into an ISO container and weigh no more than 25 tonnes. Compact reactors may typically have a capacity suitable for processing about 60000 m³/day of associated gas.

The term “synthesis gas reactor” or “syngas reactor” in this specification refers to a reactor which produces synthetic gas when provided with a suitable feed gas that contains hydrocarbon.

The invention will now be further and more particularly described, by way of example only, and with reference to the accompanying drawings in which:

FIG. 1 shows graphically the typical variation of the flow rate of associated gas with time for an oil-producing facility, and also the gas flow requirement of a conventional GTL plant;

FIG. 2 shows graphically the typical variation of productivity with time for an oil-producing facility, with and without use of the present invention;

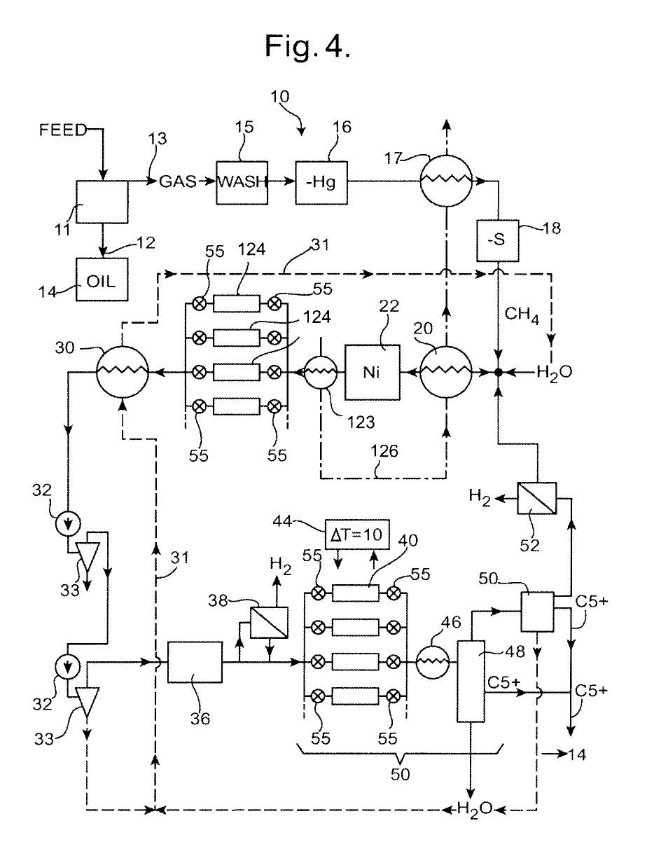

FIG. 3 shows a flow diagram of one example of a process plant for performing the process of the invention;

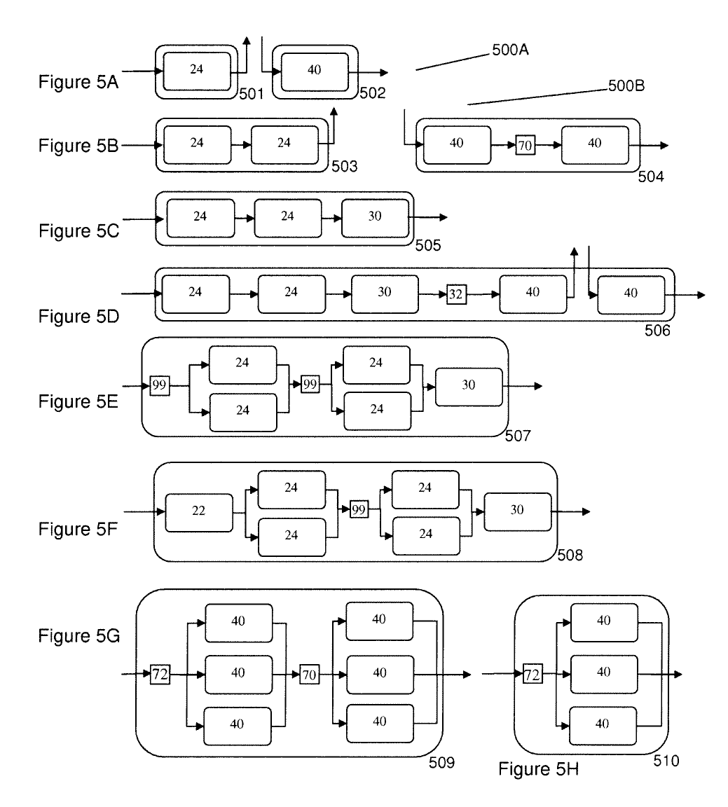

FIG. 4 shows a flow diagram of a further example of a process plant for performing the process of the invention;

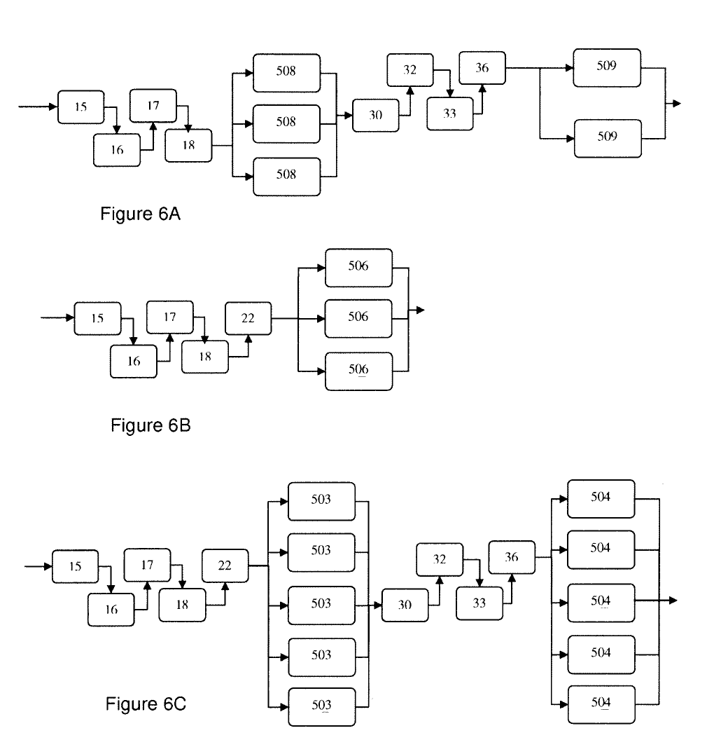

FIGS. 5A to 5H are schematic representations of a number of different examples of modules;

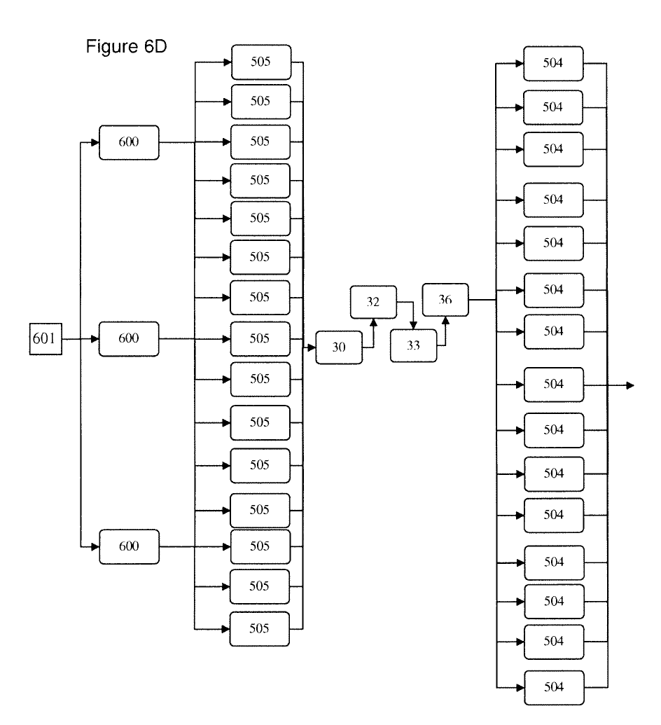

FIGS. 6A to 6D are schematic representations of a number of different examples of plants created from combinations of the modules of FIG. 5; and

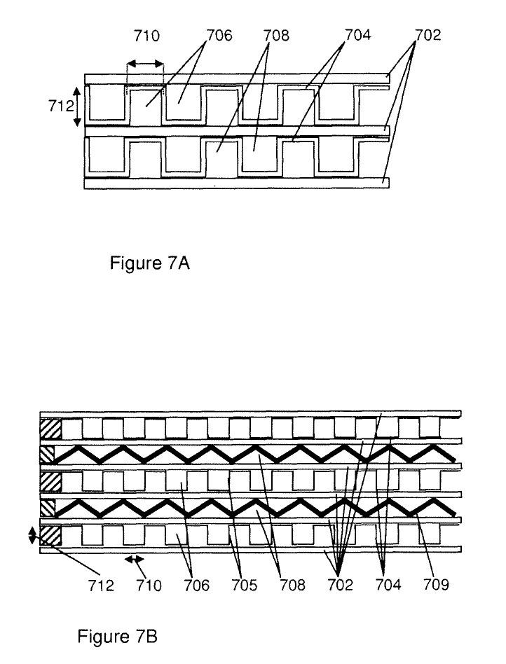

FIGS. 7A and 7B show two example cross sections through part of a reactor.

The plant and processes of the invention are applicable to an oil well that produces associated gas along with oil, wherein the gas to oil ratio is preferably between about 35 and 350 m³/m³. Referring to FIG. 2, this represents the variation of productivity, P, with time in a schematic fashion. As shown by the solid line, once oil production has started at an oil well the productivity, P, typically initially increases (A), and then reaches a plateau (B). The productivity P may then remain substantially constant for a period of years, but then starts a gradual decrease (C), and this decrease can also last for a period of years. The variation of productivity when using the present invention is represented by the broken line (D). The productivity is somewhat higher throughout the operation of the oil well because associated gas is converted to longer chain hydrocarbons which are combined with and so increase the quantity of oil from the well. In addition, the productivity from the well being higher means that economic operation of the well can continue for a longer period of time. As described above in relation to FIG. 1, the associated gas production rate G from a well varies in a similar way to the variation in productivity P of oil.

Referring now to FIGS. 3 and 4, these figures show alternative flow diagrams of a process plant 10 for performing the process. Throughout the following description like reference numerals will be used for substantially identical components in the plant illustrated in each of FIGS. 3 and 4. FIG. 3 shows a flow diagram of a process plant in which the syngas is generated by steam methane reforming. FIG. 4 shows a flow diagram of a process plant in which the syngas is generated using Ion Transfer Membranes.

In the process plants shown in both FIG. 3 and FIG. 4, the fluid produced by the oil well (indicated by “feed”) is fed into a separator 11 in which the crude oil 12 separates from the associated natural gas 13. The oil 12 is stored in an oil storage tank 14. The associated gas 13 is then conditioned to remove impurities, firstly by washing 15 with a spray of water (or by cooling and coalescing an aerosol of liquid droplets), to remove saline contaminants, then by mercury removal 16, followed by passage through a heat exchanger 17 after which it is subjected to sulphur removal 18. This produces a stream of natural gas, typically about 90% methane with small percentages of other alkanes.

The treated natural gas is then combined with steam at an elevated temperature and heated through a second heat exchanger 20 to a temperature of about 400° C. It is then subjected to pre-reforming 22 (which may for example use a nickel catalyst); this converts any C2+ hydrocarbons (ethane, propane, butane etc) to methane and carbon monoxide, and the pre-reforming 22 would not be required if the natural gas 13 contained a negligible proportion of higher alkanes. The flows are selected to provide a suitable steam:methane molar ratio after the pre-reforming treatment 22. For example, in the example shown in FIG. 4, the steam to methane ratio may be in the range of from 0:1 up to 1.5:1. Alternatively, in the example shown in FIG. 3, the steam to methane ratio is preferably between 1.4 to 1 and 1.6 to 1, more preferably 1.5 to 1. The resulting gas mixture (which primarily consists of methane and steam) is then passed through a plurality of equivalent modular synthesis gas generating reactors 24, 124 through which the flows are in parallel.

In the process shown in FIG. 3, each reactor 24 defines channels for the steam/methane reforming reaction containing reforming catalyst, for example a platinum/rhodium catalyst on an alumina support. Additional channels provide heat from catalytic combustion and contain a combustion catalyst (for example platinum or palladium catalyst on an alumina support). The gases supplied to the combustion channels may comprise air and methane, the methane supply being taken from the natural gas at the outlet from the desulphurisation process 18. The hot exhaust gases from the combustion channels (indicated by the chain dotted line 26) are then used to heat the gases passing through the heat exchangers 20 and 17. In passing through the reforming channels, the gas mixture is heated to a maximum temperature of about 750° C. and the methane and steam react to form carbon monoxide and hydrogen, this reaction being endothermic. The resulting carbon monoxide and hydrogen mixture is referred to as synthesis gas or syngas. In this case, the ratio of hydrogen to CO is about 3:1. The gas pressure within the reforming channels is 2.5 bar(a)=0.25 MPa.

In the process shown in FIG. 4, each reactor 124 comprises one or more stacks of ceramic wafers through which oxygen ions can diffuse, for example as described in U.S. Pat. No. 7,279,027, the details of which are incorporated herein by reference, which may be enclosed within a pressure vessel and may be combined with steam methane reforming catalysts, for example as described in U.S. Pat. No. 7,179,323. Such a reactor defines channels for reactants (e.g. a steam/methane mixture) and separate channels for an oxygen-containing gas such as air, separated by a ceramic membrane that allows oxygen ions to diffuse into the methane-containing stream. The gases supplied to both channels may be preheated, for example by passage through a reactor 123 along flow channels adjacent to channels in which combustion takes place (or in a heat exchanger to exchange heat with hot exhaust gases from a combustion process). This preheating reactor 123 is equivalent to the heat exchanger 20, but arranged after the pre-reformer 22. If the reactions occurring in the reactors 124 are sufficiently exothermic (which depends on the proportion of steam fed with the methane and the rate of oxygen ion diffusion into the reaction environment) then the outflowing gases may be sufficiently hot that they may be passed through a heat-exchanger 30, as shown, to provide at least part of this preheating. Preheating the gases assists the efficiency of the partial oxidation reaction that occurs in the reaction channels. As a result, the use of ITMs may provide an overall simplification in comparison with known steam methane reforming reactors as no separate heating process is required within the ITM reactors 124. The exhaust gases from the combustion process in the reactor 123 may then be passed through the heat exchanger 20 (as indicated by the chain dotted line 126).

At the outlet from the syngas reactors 24, 124 the resulting synthesis gas is quenched by passage through a heat exchanger 30 to provide the steam supplied (as shown by the broken line 31) to the inlet of the heat exchanger 20. The synthesis gas may then be subjected to one or more successive compression stages 32 (two stages 32 are shown in FIG. 4 and three stages are shown in FIG. 3) with cooling (not shown) and removal 33 of any condensed water vapour either after each compression stage 32 or if required, to ensure the synthesis gas is at the pressure required for the subsequent Fischer-Tropsch synthesis, which may be for example at 26 bar(a)=2.6 MPa. The high pressure synthesis gas is then passed through a nickel carbonyl trap 36 and then to one or more Fischer-Tropsch synthesis reactors 40 through which the flows are in parallel. When a plurality of Fischer-Tropsch synthesis reactors 40 is provided, the reactors 40 are modular and equivalent. Each reactor 40 defines channels for the Fischer-Tropsch reaction containing a suitable catalyst, for example cobalt on an alumina support, and channels for a heat exchange fluid to remove the heat generated by the synthesis reaction. The heat exchange fluid is circulated through a temperature control system 44 (represented diagrammatically) and the flow rate of the heat exchange fluid is such that its temperature increase on passing through the reactor 40 is maintained within desired limits, for example being no more than 10 K.

The fluid mixture emerging from the synthesis reactors 40 is cooled through a heat exchanger 46 and separated by a separator 48 into water, liquid hydrocarbons C5+, and remaining tail gases. The coolant used for the heat exchanger 46 may be a fluid such as water and may be at ambient temperature, for example at about 20 or 30° C. or, more preferably, at slightly higher temperatures, for example between 60 and 80° C. This higher temperature coolant substantially prevents waxing of surfaces within the heat exchanger 46. The water from the separator 48 is recycled to the quenching heat exchanger 30, as shown by the broken line 31, although it may first be treated to remove any impurities. The liquid hydrocarbons C5+ from the separator 48 are combined with the crude oil 12 in the storage tank 14, thereby increasing the volume of oil. The mixing of the liquid hydrocarbons C5+ with the crude oil 12 may take place upstream of the storage tank 14. The synthesis reactors 40 with the associated temperature control system 44 and the output heat exchanger 46 and the separator 48 may together be referred to as a synthesis assembly 50. The tail gas from the separator 48 is fed through a second such synthesis assembly 50 (shown diagrammatically), and the tail gas from the second synthesis assembly 50 is fed back to the inlet of the heat exchanger 20.

In the plant 10 of FIG. 3, the synthesis gas produced by the steam reforming reactors 24 has a hydrogen:CO ratio of about 3:1, whereas the Fischer-Tropsch reaction, for stoichiometry, requires a ratio of 2:1. Therefore, there is an excess of hydrogen in the process. In this flow diagram, some of the high pressure synthesis gas from the outlet of the nickel carbonyl trap 36 is diverted through a membrane unit 38 to separate some of the hydrogen, preferably the flow through the membrane unit 38 being such that the hydrogen:CO ratio is closer to 2:1, for example between 2.4 and 2.1:1 at the inlet to the Fischer-Tropsch reactors 40. The tail gas from the second synthesis assembly 50 also contains some hydrogen and this gas stream is also passed through a membrane unit 52 to remove this hydrogen, so that the recycled gas stream fed back to the inlet of the heat exchanger 20 consists primarily of short chain alkanes, carbon monoxide, carbon dioxide and water vapour.

In the plant 10 of FIG. 4, depending on the composition of the gas mixture supplied to the ITM reactors 124, the synthesis gas produced by the ITM reactors 124 may have a hydrogen:CO ratio (syngas ratio) of up to about 3:1, i.e. a stoichiometry that is not ideal for that required by the Fischer-Tropsch reaction. If there is an excess of hydrogen, some of the synthesis gas upstream of the FT reactors may be diverted through a membrane unit 38 to separate some of the hydrogen so that the syngas ratio is reduced to a value closer to 2:1. The tail gas from the second synthesis assembly 50 may also contain some hydrogen and this gas stream is also passed through a membrane unit 52 to remove this hydrogen, so that the recycled gas stream fed back to the inlet of the heat exchanger 20 consists primarily of short chain alkanes, carbon monoxide, carbon dioxide and water vapour.

The overall result is that the associated gas 13 is converted to longer chain hydrocarbons C5+ which are liquids, and are then combined with the oil in the storage tank 14. The water by-product from the synthesis assemblies 50 is fed back as indicated by broken line 31 to provide steam for the process. The hydrogen extracted by the membrane unit 38 and the membrane unit 52 may be used as a source of fuel, for example to provide power for operation of the compressors 32.

As explained in relation to FIG. 1, the flow rate G of associated gas 13 varies with time over the life of the well, and in addition (as discussed earlier) there are also shorter term variations, so that the plant 10 must be able to deal with a wide range of different gas flows. Some of the process units within the process plant 10 can work equally well for a wide range of different gas flow rates. However, there is a particular problem with the reactor units, particularly the syngas reactors 24, 124 and the synthesis reactors 40, for which the performance varies significantly with gas flow rate. For this reason each reactor 24 and each reactor 40 is provided with shut-off valves 55 at all its inlets and its outlets (only two of which are shown for each reactor), so that individual reactors 24, 124 and 40 can be taken out of use without affecting operation of the remainder of the process plant 10.

For the steam reforming reactors 24, locating a shut off valve on the hot side (>500° C.) of the process (i.e. on the hot process outlet (and hot combustion outlet)) provides one option. Alternatively, each reactor 24 may be provided with a dedicated quench heat exchanger, analogous to heat exchanger 30 and the shut off valve 55 can then be located on the outlet side of the quench heat exchanger. Likewise, on the hot combustion side, each reactor 24 can be provided with a hot shut off valve. An alternative is to provide the reactor 24 with a dedicated heat recuperator analogous to the heat recuperator 20 so that the shut off valve can be located on the outlet side of the recuperator at about 200-500° C.

In this way, individual reactors 24, 124 and 40 can be taken out of use without affecting operation of the remainder of the plant 10.

If the flow rate, G, of associated gas increases during operation, the reactors 24, 124 and 40 that have been taken out of use can be readily brought back into use. It will also be appreciated that, except when the plant 10 is operating at its full capacity, there will be some reactors 24, 124 and 40 that are not in use. This provides a degree of redundancy if there should be a malfunction in one of the other reactors 24, 124 or 40. Hence the malfunctioning reactor 24, 124 or 40 can be shut-off and another reactor 24, 124 or 40 brought into use. This is a far more rapid process than that of removing and replacing a reactor.

In practice, the shut off valves 55 may be used in pairs, with at least one valve isolating the process side and one valve isolating the reactor side, the valves of a pair being separated by a short length of pipe that can be purged and filled with inert gas to remove atmospheric oxygen prior to reactor start up. A blanking plate can be provided between the two valves of a pair in order to isolate the reactor positively.

When it is necessary to shut-off one of the synthesis reactors 40, the shut-off valves 55 on both sides of the reactor 40 are both closed. At the same time, the reactor 40 is flushed through with an inert gas at the operating pressure (26 bar(a) in this example) from a shutdown gas supply (not shown) to remove any remaining synthesis gas. The reactor 40 is then closed in at the operating pressure by also closing the connections to the shutdown gas supply. This ensures that any catalyst does not deteriorate. Thus, the shutdown or inert gas is a gas that is not involved in the catalytic reaction, thereby substantially preventing further catalytic activity in the reactor. For example this inert gas may be pure methane, de-sulphurised natural gas, or nitrogen. The reactors 24, 124 and 40 may be provided with thermal insulation so that they do not cool down rapidly after being shut-off in this fashion. Indeed, when dealing with a short-term decrease in gas flow, it may be desirable to provide a source of heat to the reactor 24, 124 or 40 so that it can return more rapidly to full operation once the reactor 24, 124 or 40 is reconnected.

It will also be appreciated that this procedure enables individual reactors to be removed and replaced while not in use, for example if a reactor needs to be refurbished for example to replace spent catalysts. The removed reactor may be transported to a remote site at which refurbishment is carried out, for example by replacing the catalysts. Hence there is no need to provide catalyst handling equipment at the oil-producing facility.

The process plant 10 is for use at an oil-producing facility and therefore is of such a size as to fit on a fixed oil platform or on an FPSO vessel, or whatever form the facility may take. In particular, each process unit within the process plant 10 should be of such a size that it can be handled by conventional cargo handling equipment so that the process plant can be installed or maintained. In particular, each reactor 24, 124 and 40 should be no more than about 25 tonnes and small enough to fit within the dimensions of an ISO container. For example each reactor 24, 124 and 40 may be about 10 tonnes, being of overall length about 8 m and having a capacity suitable for processing about 60000 m³/day (2 Mscf/day) of associated gas 13. The detailed design of the reactors 24, 124 and 40 is not an aspect of the present invention but it will be understood that each reactor must be a compact reactor, that is to say providing a large surface area for heat exchange (and also for catalyst, where provided) within a small volume.

Within the ITM syngas reactors 124 the channels would typically be between 0.3 mm and 5 mm high (the smallest transverse dimension), whilst the combustion channels and the reforming channels within steam methane reforming reactors 24 are typically between 1 and 5 mm high (the smallest transverse dimension).

Within the synthesis reactors 40, the coolant channels would typically be between 1 and 5 mm high, while the channels for the Fischer-Tropsch reaction might be slightly higher, typically being between 4 and 12 mm high. In those channels where a catalyst is provided, the catalyst may be provided as a coating on the wall of the channel, or as a bed of catalyst particles, or as a coating on a metal substrate that can be inserted into the channel. The catalyst insert may subdivide the channel into a multiplicity of parallel sub-channels, for example a corrugated foil.

The reactors 24, 124, 40 in FIGS. 3 and 4 are shown as distinct reactors connected in parallel. However, it should be understood this is figure is merely schematic. In practice, manufacturing procedures place effective limits on the size of a reactor block. Each of the reactors 24, 124, 40 may comprise one or more reactor blocks. The blocks of each reactor 24, 124, 40 may be interspersed with blocks of a second reactor of the same type in order to perform the reaction in two stages and each block provided with a header to cause the fluid flows to move from one reactor to the next. Neighbouring blocks, whether they form part of the same reactor or not, may be fixed together. If the neighbouring blocks are all part of the same reactor then a single common header may communicate with the reactor as a whole.

A module may be defined as a part of a plant that can be independently isolated from the remainder of the plant without compromising the operability of the plant. The module may or may not incorporate the means required to isolate it, such as shut-off valves. In the context of the plant schematics shown in FIGS. 3 and 4, a module may be a single reactor 24, 124, 40 with or without the shut-off valves 55 and/or the quench heat exchanger analogous to heat exchanger 30 and/or a recuperator analogous to the recuperator 20. Alternatively, a module may be defined as a part of the plant that can be independently removed from the plant after being isolated. If the module is to be removed independently then shut-off valves analogous to valves 55 must be provided at least external to the module in order to close off the remainder of the plant from the module in order to facilitate the removal of the module from the plant. Depending on which components form part of the module, the provision of one or more valves external to the module does not preclude the provision of one or more additional valves as part of the module.

In a further alternative, once a module has been isolated from the remainder of the plant, one or more components of the module may be removed. In order to facilitate this, valves may be provided between the components of the module. This configuration is advantageous in the situation where a module comprises a number of reactors and further components such as quench heat exchangers and/or pre-heaters and/or pre-reformers. If one reactor within the module develops a fault, the entire module can be isolated so that the remainder of the plant can continue to function. However, rather than removing the entire module, the faulty reactor can be isolated from the remainder of the module and can be removed separately. In this case, the faulty reactor is itself also effectively a “module” as it can be isolated and removed.

FIG. 5 shows a number of different module configurations. Each of the configurations shown in FIG. 5 shows only the process stream through the module. In all of the illustrated configurations process flow occurs from left the right in the diagrams. In addition, the numeral 24 has been used to denote an example of a reactor used for syngas generation. However, it will be apparent that all of the illustrated module configurations would apply equally to the situation when the syngas generation occurs using reactor 124 that operates using ITMs.

The simplest configuration of the modules that form part of a plant 500A for processing natural gas is shown in FIG. 5A. In this configuration, each module 501, 502 consists solely of a single reactor 24, 40. Once the associated gas has been pre-treated it is introduced into the first module 501 which is a syngas generating reactor 24. The syngas exits the first module 501 and is prepared for Fischer-Tropsch synthesis in other parts of the plant. The syngas is then introduced into the module 502, which is a reactor 40, where it undergoes Fischer-Tropsch synthesis to result in synthetic crude oil. This configuration is equivalent to the plants shown in more detail in FIGS. 3 and 4.

FIG. 5B shows a plant 500B comprising two modules 503, 504 each of which includes two reactors operating in series. In module 503 a two-stage syngas generation takes place and in module 504 a two-stage Fischer-Tropsch synthesis takes place. In each case, a module may include means to treat one or other of the fluid flows between the stages, for example, following the first stage Fischer-Tropsch synthesis the output is subjected to cooling, phase separation and preheating 76. These steps are collectively denoted as inter-stage treatment 70.

FIG. 5C shows a syngas generation module 505 in which the waste heat boiler or steam generator 30 is incorporated into the module.

In addition to the reactors 24, 40, the module may include valves for the isolation of the reactors 24, 40. By providing valves within the modules, the reactors 24, 40 can be isolated from any other components within the module. In this way, the reactors 24, 40 can be removed from within the module. Alternatively, valves may only be provided in order to allow for the module to be isolated from the rest of the plant. The valves are not illustrated in any of the examples shown in FIG. 5 and it should be understood that in each case valves may be provided within the module in place of or in addition to valves placed external to the module for isolating the module as a whole.

FIG. 5D shows a GTL module 506 which includes two syngas generation reactors 24, a waste heat boiler or steam generator 30; a compressor 32 and then two Fischer-Tropsch reactors 40. Between the two stages of Fischer-Tropsch synthesis phase separation and pre-heating are carried out. However, as the components required for these activities are not included within this module 506 the output from the first Fischer-Tropsch reactor is routed out of the module where it is subjected to phase separation and then pre-heating prior to being reintroduced into the module 506 for a second phase of Fischer-Tropsch synthesis.

As a result of the provision of both syngas generation and Fischer-Tropsch synthesis within a single module 506, this module may alternatively be referred to as a train.

FIG. 5E shows a syngas generation module 507 which is similar to that illustrated in FIG. 5C except that the module 507 comprises four syngas generating reactors providing two-stage syngas generation. For each stage, there are two reactors in parallel. The outputs of the two first stage reactors are combined in a manifold 99 before being divided and fed into the two second stage reactors. The output from the two second stage syngas generation reactors is then introduced into a heat exchanger 30 or waste-heat boiler in which the heat from the syngas is used to generate steam.

The provision of the manifold 99 enables any disparity in the performance of the two first stage reactors to be smoothed out so that one of the second stage reactors does not suffer unduly from a sub-optimal performance from one of the first stage reactors.

FIG. 5F shows a syngas generation module 508 which is similar to that illustrated in FIG. 5E except that the pre-reformer 22 is incorporated within the module 508.

FIG. 5G shows a Fischer-Tropsch module 509 that includes three parallel lines of two-stage Fischer-Tropsch synthesis reactors 40. The syngas is first preheated in a preheater 76. Following the first stage Fischer-Tropsch synthesis the output from the three first stage reactors is combined and subjected to cooling, phase separation and preheating in inter-stage treatment 70. The output from the preheater is divided equally between the three second stage Fischer-Tropsch reactors 40.

FIG. 5H shows a module 510 comprising three Fischer-Tropsch modules in parallel. This module 510 would be combined in series with another similar module in order to provide two-stage Fischer-Tropsch synthesis. Alternatively, two modules 510 may be provided in parallel for the first stage Fischer-Tropsch synthesis and then a single module may be provided for the second stage Fischer-Tropsch synthesis. The single module may comprise only five reactors 40 in parallel, in comparison with the six reactors 40 in the two parallel modules 510.

In order to create a GTL plant a number of modules are combined as shown in FIG. 6. Typically, the plant will be made up of a number of modules 501, 503, 507, 508 comprising syngas reactors 24, 124 and a number of modules 502, 504, 509, 510 comprising Fischer-Tropsch synthesis reactors 40. One example of a configuration of a GTL plant is shown in FIG. 6A. All of the syngas generating modules 508 are connected in parallel so that any one can be shut down and subsequently optionally removed without requiring the remaining modules to be shut down. Similarly, all of the Fischer-Tropsch modules 509 are connected in parallel.

Alternatively, the plant may be made up of a number of modules 506 connected in parallel as shown in FIG. 6b.

A further example of a GTL plant is shown in FIG. 6C. This example comprises five two-stage syngas generating modules 503 and five two-stage Fischer-Tropsch synthesis modules 504.

In a very large plant such as that shown in FIG. 6D, the auxiliary components that treat the gas before it is introduced into the first module 505 comprising one or more syngas reactors, may also be modularised. In particular, the wash 15, mercury removal 16, heat exchanger 17 and desulphurisation unit 18 may be combined into an auxiliary module 600. Feed gas is introduced to the plant via a common manifold 601.

In the example shown, fifteen modules 505 are connected in parallel. One auxiliary module 600 is capable of servicing five modules 505 containing syngas generating reactors. Therefore three auxiliary modules 600 are provided in order to service the fifteen modules 505. As the production of the gas well declines and modules 505, 504 are switched off and removed, so too are auxiliary modules 600. The provision of more than one auxiliary module 600, in parallel, as shown reduces the extent to which turndown limitations on the auxiliary components would limit the extent to which the plant as a whole can be turned down.

Modules with a smaller capacity, whether that capacity is obtained by the number of reactors or the size of each reactor, provide smaller increments when the capacity of the plant as a whole is considered. However, a plant comprising a large number of modules has the added complexity of extensive connecting pipework and valves. This added complexity adds to the cost. The size of the modules and the number of modules within a plant is therefore a compromise between these factors. In addition, the size of a module is constrained by the requirements above mentioned with regard to it being sized to fit within the frame of a standard ISO container.

The modular approach provides considerable advantages over a non-modular approach to processing associated gas. Previously, within this application modular systems have been envisaged that comprise two or more substantially identical modules for each reaction, for example, syngas generation and Fischer-Tropsch synthesis. However, in order to create a more flexible, yet cost effective system, the modules configured to operate in parallel and to carry out the same reaction may have different properties.

A robust module is a module which includes at least one robust reactor. A robust reactor is a reactor that has improved tolerance to transient changes in process conditions in comparison with an economical module. The robustness of a reactor, that is to say its ability to tolerate such transient changes, can be modified in a number of different ways as set out below.

Within each of the reactors 24, 40 that are provided within the modules 501 to 510 there may be a plate and fin structure. The plate and fin structure comprises a stack of flat plates 702 interspersed with shaped plates 704, 709. The combination of the shaped plates 704, 709 and the flat plates 702 define flow channels. Alternate sets of flow channels within the stack have different purposes. For example as illustrated schematically in FIG. 7A, in a syngas generating reactor 24, the first flow channels 706 are configured to contain catalyst bearing foils and steam methane reforming takes place in these channels. The adjacent or second flow channels 708 are configured to contain foils bearing a combustion catalyst. Because both sets of channels 706, 708 are configured to contain catalyst bearing foils, both sets are defined by plates 704 which have rectangular castellations. The castellated plates 704 are shaped to define a number of fins 705 which extend perpendicular to the plane of the plates 702. Although the castellated plates 704 defining the channels 706, 708 may be identical as shown in FIG. 7A, they may alternatively be configured to define differently sized channels 706, 708.

In contrast, in a Fischer-Tropsch reactor 40, the first flow channels 706 are configured to contain catalyst bearing foils, but the second flow channels 708 are configured to contain a fluid to manage the heat from the Fischer-Tropsch synthesis channels 706. The plates 709 defining the second flow channels may have a sawtooth profile. This configuration is illustrated schematically in FIG. 7B.

The thickness, separation and height of the fins 705 can be altered in order to change the robustness of a reactor. The fin separation 710 is the distance between adjacent fins 705 that extend perpendicular to the plates 702. A reactor having a plate and fin structure with a small fin separation, for example 2 mm will be more robust than a reactor with a larger fin separation for example 20 mm. The fin height 712 is the distance over which the fin extends in a direction perpendicular to the plane of the plates 702. It is also effectively the distance by which the plates 702 are separated. The fin height may be within the range of 2 mm to 20 mm and the less the height the more robust the reactor.

The thickness of the plates 702, 704 can also be modified in order to affect the robustness of the reactor. In particular, the thickness of the shaped plates 704, 709 may be within the range of 0.3 mm to 1 mm. The flat plates 702 may be within the range of 1 mm to 3 mm.

Decreasing the fin separation and height and decreasing the thickness of the flat plates 702 increases the heat exchange area per unit volume of the reactor resulting in better heat transfer that is better able to dissipate thermal transients and therefore to avoid the large thermal gradients that can stress the structure and result in damage to the reactor or shorten the lifetime of the reactor. In addition, decreasing the fin separation and height also results in an increased metal inventory and an increased mechanical strength within the reactor which results in a heavier and more expensive reactor. A robust reactor can be fabricated using one or more of the above mentioned changes to the plate and fin configuration. From the foregoing it will be apparent that robustness is not always synonymous with mechanical strength because if the flat plates 702 are reduced in their thickness, then the reactor will have a lower mechanical strength, but the reactor will be more robust because the thinner flat plates 702 allow increased heat transfer between the flow channels and thereby reduce the temperature differentials within the reactor, thereby reducing the stresses on the reactor.

The robustness of a reactor can also be increased by changing the material from which the plates 702, 704 are fabricated. For example, in a reactor configured to carry out Fischer-Tropsch synthesis the plates 702, 704 could be made from brazed aluminium. However, in a robust Fischer-Tropsch reactor the plates 702, 704 may be made from stainless steel or titanium.

Furthermore, the manufacturing method used may differ between economical and robust reactors. Reactors that have a plate and fin configuration may be created by a process of brazing or diffusion bonding. Typically, diffusion bonding requires a higher metal inventory than brazing which might make it more appropriate for certain types of robust reactor. Alternatively, a robust reactor could be created from a block of metal using the technique of wire erosion, rather than by fusing plates by either of the above mentioned techniques.

In addition, or in place of the above mentioned changes to the materials, bonding and/or plate and fin configuration and materials used within a reactor, changes to the catalyst can also change the robustness of a reactor.

The catalyst may be supported on a ceramic coating on convoluted or corrugated foils that are introduced into the channels 706. In a robust reactor the catalyst can be less active and the process length increased, thereby producing a reduction in intensification i.e. the extent of the process carried out per unit length of channel is reduced. The catalyst can be made less active by changing the size of the crystallites deposited within and on the ceramic support or by depositing less catalyst per unit length. Furthermore, an inert coating may be provided to cover at least a part of the catalyst in order to impede access of fluids to and from the active catalytic material.

Further changes to the reactor configuration may be combined with the changes to the plate and fin configuration and/or changes to the catalyst in order to provide a robust reactor. For example, the number and size of the headers may be altered.

An economical module is one in which the or all of the reactors are economical reactors. A robust module is a module that contains at least one robust reactor and is more robust than an economical module. In general, if a module contains more than one reactor, then all of the reactors that are configured in parallel should be equally robust. For example, the two reactors within module 503 may be identical. However, when completing two-stage syngas generation, the system conditions may be optimised differently in the two reactors and therefore, the first stage reactor may be more robust than the second stage reactor.

In contrast the two stages of Fischer-Tropsch synthesis are usually run under substantially identical conditions and therefore if one reactor of a two-stage pair of Fischer-Tropsch reactors in a module is a robust reactor, then both should be robust.

In order to control a plant that is processing associated gas, a control system is required.

The challenges faced by a plant processing associated gas are unique. In most contexts other than that of a plant processing associated gas, the inputs to the plant can be controlled. In contrast, the flow of associated gas varies considerably and cannot be controlled. There are different types of variation in the flow of associated gas and these require differing responses.

Firstly, as illustrated in FIG. 2, the flow rate of associated gas produced by an oil well decreases over the life of the field. In order to capitalise on the advantages of the modular plant, the mean flow rate of associated gas produced must be monitored by the control system. The flow rate is measured and then subjected to statistical analysis which smoothes the data to avoid giving undue attention to a short lived fluctuation a number of standard deviations from the mean. When the daily mean flow rate of gas, as a proportion of the flow rate when at full capacity, has not exceeded 100(n−1)/(n)/% (where n is the number of syngas generation modules) for more than six months or other predetermined trigger time period, the control system indicates that one of the modules should be shut down. In this case it will generally be an economical module that is selected for shut down, to ensure that the plant still includes at least one robust module. Once a module has been shut down, it may be retained in order to provide the plant with redundancy in case one of the remaining modules malfunctions. Alternatively, once a module has been shut down, it may be removed from the plant for servicing and/or redeployment as part of a different plant.

The trigger time period may range from three to eighteen months depending on the size of the plant and the rate at which the productivity of the oil well(s) is decreasing. For example, if a large plant is deployed then the percentage drop in productivity required to make a module redundant will be comparatively small. If, in addition the productivity of the oil well is declining rapidly then the trigger time period may be only three to six months.

For example, in the plant shown in FIG. 6B, when the flow rate of associated gas does not exceed 67% of full capacity for more than six months, one of the modules 506 will be shut down. Once one of the modules 506 has been shut down only two modules 506 will remain in use and therefore “full capacity” for the plant with two modules is 67% of the original value. When the gas flow rate declines to 50% of the full capacity of the two module plant for more than, say six months, one of the two remaining modules will be shut down.

In the circumstance in which each module comprises only syngas generation reactors or only Fischer-Tropsch synthesis reactors, one module of each type, i.e. two modules in total, will be removed from the plant. For example, in the plant shown in FIG. 6C, when the daily mean flow of gas does not exceed 80% for more than 6 months, one of the modules 505 and one of the modules 504 may be shut down.

Secondly, the flow of associated gas will be subject to hour by hour fluctuations. Fluctuations are random variations in the flow of associated gas that represent deviations of up to +/−15% about the mean gas flow rate. These fluctuations occur over too short a time frame for the modules to be switched off and on in order to respond. Therefore, the control system will simply turn the modules up or down in order to deal with fluctuations.

When the gas flow drops beyond the turndown limit of the plant, one module must be shut down. The control system will select a robust module which can be switched off and, if the drop in gas flow is expected to be short lived, a robust module can be filled with inert gas and the thermal inertia of the robust module can be relied upon to keep the module close to operating temperature for longer than an economical module. This may apply to each stage of the process, so for example, in a plant like that of FIG. 3, if the gas flow drops beyond the turndown limit and the drop is expected to be short-lived, one robust SMR reactor 24 and one robust FT reactor 40 would be switched off. Alternatively, it may apply only to one stage of the process, for example to syngas generation. In this case, all of the Fischer-Tropsch reactors 40 may be equally robust.

Because the throughput of a plant processing associated gas from a single well is inextricably linked to the productivity of the well, the control system is configured in order to respond to the loss of the well. This may occur unexpectedly. In such a circumstance the flow of associated gas will drop to zero over a comparatively short time period. In this circumstance the control system is configured to oversee the controlled turning off all modules. Depending on the availability of methanol and the expected duration of the loss of gas flow, the control system will transition at least the economical SMR modules to running on methanol as a combustion fuel.

In addition to variability in the flow of gas entering the plant, transient conditions may be created in one part of the plant which create transient changes in process conditions in other parts of the plant. For example, if the process is configured such that an output from one module is fed back into another module further upstream through the process, this creates a feedback loop that can also result in a change in process conditions that produces transient changes in the process conditions as a whole. One example of this occurs in a GTL plant comprising syngas generating modules and Fischer-Tropsch modules when the carbon containing components of the tail gas from the Fischer-Tropsch module(s) are fed back into the pre-reformer positioned upstream of one or more of the syngas generating modules. When the syngas generating modules are started up initially, there will not typically be any tail gas from the Fischer-Tropsch modules that can be introduced. Once the tail gas becomes available, it will be introduced into the pre-reformer, closing the feedback loop. The closure of this loop will result in a transient change in process conditions in the syngas generating reactors. Therefore, it is advantageous if the robust modules are activated first and the feedback loop completed. Once the system has been stabilised, the economical modules can be brought online.

The control system also monitors the composition of the liquid outflow from the Fischer-Tropsch modules. It is preferable if the composition of the plant output can be matched to the composition of the crude oil output by the oil well. The composition of the synthetic crude oil output by the Fischer-Tropsch modules can be altered by changing the temperature and syngas composition in the Fischer-Tropsch reactors. The control system is configured to change the temperature in the Fischer-Tropsch reactors by changing the temperature of the fluid in the coolant channels and/or the temperature to which the syngas is preheated before being introduced into the Fischer-Tropsch reactors.

Moreover, the composition of the syncrude will vary depending on the catalyst that is provided within the channels 706 of the Fischer-Tropsch reactor 40. In order to modify the percentage of different hydrocarbons within the syncrude, different catalysts can be used. The control system may therefore be configured to recommend that, for example, when one Fischer-Tropsch module has to be replaced, it could be replaced with a Fischer-Tropsch module containing reactors with a different catalyst in order to select the desired composition of syncrude output from the plant as a whole.

The control system includes a performance monitoring system and a plurality of valves configured to control various aspects of each reactor 24, 124, 40 and the plant as a whole.

The performance monitoring system measures the temperature, pressure, flow and composition of the fluids flowing through each module and the plant as a whole. The measured parameters are used to monitor short term changes in the system such as a decrease in the available feed gas requiring one or more of the modules to be turned down. In addition, the measured parameters are used to observe longer term trends. For example, an increase in temperature or a decrease in the CO and/or H₂ content of the syngas forming the fluid output of a steam methane reforming reactor for a given input temperature indicates that the catalyst within the reactor is degrading and may require regeneration or replacement.

Because the plant is comprised of a number of modules operating in parallel, the initial conditioning of Fischer-Tropsch catalysts or the regeneration of either steam methane reforming or Fischer-Tropsch catalysts may be carried out in situ whilst the remainder of the plant is operational. The reduction of catalysts can be carried out, where applicable, using H₂ from other modules that are operational.

Because the system is complex, model-based diagnostics are used as part of the performance monitoring system. The input parameters for each module, or system component are recorded and put into a model which predicts the ideal output parameters from the system for the given input parameters and the model is compared with the real data from the plant. The nature of the differences between the model data and the data from the plant can be informative in terms of the cause of the variance between the two data sets.

1. A plant for processing natural gas comprising two or more modules connected in parallel; wherein the plant is configured to convert the associated gas into a material with a higher density.

2. The plant according to claim 1, wherein at least one of the modules is a robust module.

3. The plant according to claim 2, wherein each module comprises two or more reactors connected in series or in parallel or a combination thereof.

4. The plant according to claim 1, wherein two or more of the modules are syngas generating modules that contain one or more syngas generating reactors and two or more of the modules are Fischer-Tropsch modules that contain Fischer-Tropsch reactors.

5. The plant according to claim 4, wherein all of the syngas generating modules are arranged in parallel; and wherein all of the Fischer-Tropsch modules are arranged in parallel.

6. The plant according to claim 5, wherein the outputs of a plurality of the syngas generating modules are connected to a common output manifold.

7. The plant according to claim 4, wherein there is provided at least one module that is redundant under normal operating conditions.

8. Apparatus for processing natural gas, the apparatus comprising: a production conduit for communication with an oil well in order to extract oil and associated gas; and a process unit configured to support: means for storing the oil extracted; and a plant as claimed in claim 4.

9. A method of processing gas associated with one or more oil wells, the method comprising the steps of: providing a modular plant comprising two or more modules in parallel wherein at least one of the modules is a robust module and at least one of the modules is an economical module; turning down one or more of the modules when productivity drops; turning off one or more of the modules at least when productivity drops beyond the turndown limit.

10. The method according to claim 9, wherein if the drop in productivity has a short duration, the module that is switched off is a robust module.

11. The method according to claim 9, further comprising the step of switching off one module when the flow of associated gas falls to below a predetermined threshold for in excess of a predetermined time period.

12. The method according to claim 11, wherein the module that is switched off is an economical module.

13. The method according to claim 9, wherein the modular plant is configured to convert associated gas to liquid hydrocarbons and wherein the liquid hydrocarbons are combined with the oil from the oil well(s).

14. A control system for operating a plant according to claim 4 in accordance with the method as set out in claim 9.

15. The control system according to claim 14, further comprising means for monitoring the composition of the synthetic crude oil exiting the Fischer-Tropsch reactors and means for modifying the conditions within the Fischer-Tropsch reactors in order to match or complement the composition of the output to the composition of the oil from the well(s).

16. Plant for processing natural gas comprising two or more modules connected in parallel; wherein the plant is configured to convert the associated gas into a material with a higher density, wherein the plant comprises at least one robust module and at least one economical module in parallel, the robust module having improved tolerance to transient changes in process conditions in comparison to the economical module.

17. A plant for processing natural gas comprising two or more modules connected in parallel; wherein the plant is configured to convert the associated gas into a material with a higher density, wherein at least one of the modules contains a reactor and at least one unit selected from: a heat exchanger; means to perform cooling, phase separation and preheating; or a compressor.

18. A plant for processing natural gas comprising two or more modules connected in parallel; wherein the plant is configured to convert the associated gas into a material with a higher density, wherein the plant comprises at least one robust module and at least one economical module in parallel, the robust module having improved tolerance to transient changes in process conditions in comparison to the economical module, and wherein at least one of the modules contains a reactor and at least one unit selected from: a heat exchanger; means to perform cooling, phase separation and preheating; or a compressor.
